(19) United States
(12) Patent Application Publication
(10) Pub. No.: US 2003/0066056 A1
(43) Pub. Date: Apr. 3, 2003

(54) Method and apparatus for accessing thread-privatized global storage objects

(76) Inventors: Paul M. Petersen, Champaign, IL (US); Sanjiv M. Shah, Champaign, IL (US); David K. Poulsen, Champaign, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/966,518

(22) Filed: Sep. 28, 2001

(51) Int. Cl. G06F 9/45

(52) U.S. Cl. 717/137; 717/149

(57) ABSTRACT

In an embodiment, a method includes receiving a first source code having a number of global storage objects, wherein the number of global storage objects are to be accessed by a number of threads during execution. The method also includes translating the first source code into a second source code. The translating includes adding initialization logic for each of the number of global storage objects. The initialization logic includes generating private copies of each of the number of global storage objects during execution of the second source code. The initialization logic also includes generating at least one cache object during the execution of the second source code, wherein the private copies of each of the number of global storage objects are accessed through the at least one cache object during execution of the second source code.

### FIELD OF THE INVENTION

The invention relates to the compilation and execution of code. More specifically, the invention relates to accessing of thread-privatized global storage objects during such compilation and execution.

### BACKGROUND OF THE INVENTION

Parallel computing of tasks achieves faster execution and/or enables the performance of complex tasks that single process systems cannot perform. One paradigm for performing parallel computing is shared-memory programming. The OpenMP standard is an agreed upon industry standard for programming shared memory architectures in a multi-threaded environment.

In a multi-threaded environment, privatization for global storage objects that can be accessed by a number of computer programs and/or threads is a technique that allows for parallel processing of such computer programs and thereby allow for enhancement in the speed and performance of these programs. In particular, privatization refers to a process of providing individual copies of global storage objects in a global memory address space for multiple processors or threads of execution.

One current approach to privatization can be implemented via a hardware partitioning of a computer system's physical address space into shared and private regions. In addition to the limitation of being hardware-specific, this approach suffers either from limits on the size of private storage areas, from difficulties in efficiently utilizing fixed-size global and private storage areas and from difficulties in managing ownership of various storage areas in a multiprocessing or multiprogramming environment.

### BRIEF DESCRIPTION OF THE DRAWINGS

Embodiments of the invention may be best understood by referring to the following description and accompanying drawings that illustrate such embodiments. The numbering scheme for the Figures included herein are such that the leading number for a given element in a Figure is associated with the number of the Figure. For example, system 100 can be located in FIG. 1. However, element numbers are the same for those elements that are the same across different Figures.

In the drawings:

FIG. 1 illustrates an exemplary system 100 comprising processors 102 and 104 for thread-privatizing of global storage objects, according to embodiments of the present invention.

FIG. 2 illustrates a data flow diagram for generation of a number of executable program units that includes global storage objects that have been thread-privatized, according to embodiments of the present invention.

FIG. 3 illustrates a flow diagram for the incorporation of code into program units that generates thread privatized variables for global storage objects during the execution of such code, according to embodiments of the present invention.

FIG. 4 illustrates a source code example in C/C++ showing objects being declared as “threadprivate”, according to embodiments of the present invention.

FIG. 5 illustrates a flow diagram of the initialization logic incorporated into program unit(s) 202 for each global storage object therein, according to embodiments of the present invention.

FIG. 6 shows a code segment of the initialization logic incorporated into program unit(s) 202 for each global storage object therein, according to embodiments of the present invention.

FIG. 7 shows a memory that includes a number of cache objects and memory locations to which pointers within the cache objects point, according to embodiments of the present invention.

### DETAILED DESCRIPTION

In the following description, for purposes of explanation, numerous specific details are set forth in order to provide a thorough understanding of the present invention. It will be evident, however, to one skilled in the art that the present invention may be practiced without these specific details.

Embodiments of the present invention are portable to different operating systems, hardware architectures, parallel programming paradigms, programming languages, compilers, linkers, run time environments and multi-threading environments. Moreover, embodiments of the present invention allow portions of what was executing during run time of the user's code to compile time and prior thereto. In particular, as will be described, embodiments of the present invention enable the exporting of a copy of a data structure that was internal to a run time library into the program units of the code (e.g., source code), thereby increasing the run time speed and performance of the code. A copy of the data structure is loaded into the software cache through a single access to a routine in the run time library such that subsequent accesses by the threads to their thread private variable are to the software cache and not to the run time library.

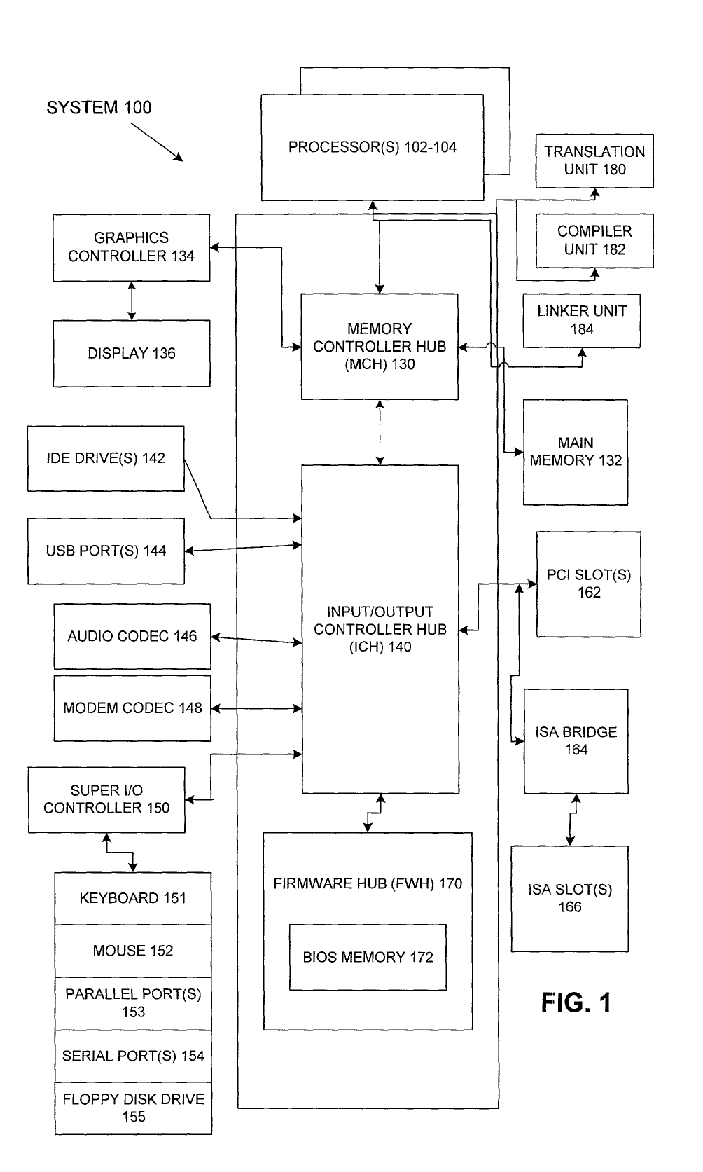

FIG. 1 illustrates an exemplary system 100 comprising processors 102 and 104 for thread-privatizing of global storage objects, according to embodiments of the present invention. Although described in the context of system 100, the present invention may be implemented in any suitable computer system comprising any suitable one or more integrated circuits.

As illustrated in FIG. 1, computer system 100 comprises processor 102 and processor 104. Computer system 100 also includes processor bus 110, and chipset 120. Processors 102 and 104 and chipset 120 are coupled to processor bus 110. Processors 102 and 104 may each comprise any suitable processor architecture and for one embodiment comprise an Intel® Architecture used, for example, in the Pentium® family of processors available from Intel® Corporation of Santa Clara, Calif. Computer system 100 for other embodiments may comprise one, three, or more processors any of which may execute a set of instructions that are in accordance with embodiments of the present invention.

Chipset 120 for one embodiment comprises memory controller hub (MCH) 130, input/output (I/O) controller hub (ICH) 140, and firmware hub (FWH) 170. MCH 130, ICH 140, and FWH 170 may each comprise any suitable circuitry and for one embodiment is each formed as a separate integrated circuit chip. Chipset 120 for other embodiments may comprise any suitable one or more integrated circuit devices.

MCH 130 may comprise any suitable interface controllers to provide for any suitable communication link to processor bus 110 and/or to any suitable device or component in communication with MCH 130. MCH 130 for one embodiment provides suitable arbitration, buffering, and coherency management for each interface.

MCH 130 is coupled to processor bus 110 and provides an interface to processors 102 and 104 over processor bus 110. Processor 102 and/or processor 104 may alternatively be combined with MCH 130 to form a single chip. MCH 130 for one embodiment also provides an interface to a main memory 132 and a graphics controller 134 each coupled to MCH 130. Main memory 132 stores data and/or instructions, for example, for computer system 100 and may comprise any suitable memory, such as a dynamic random access memory (DRAM) for example. Graphics controller 134 controls the display of information on a suitable display 136, such as a cathode ray tube (CRT) or liquid crystal display (LCD) for example, coupled to graphics controller 134. MCH 130 for one embodiment interfaces with graphics controller 134 through an accelerated graphics port (AGP). Graphics controller 134 for one embodiment may alternatively be combined with MCH 130 to form a single chip.

MCH 130 is also coupled to ICH 140 to provide access to ICH 140 through a hub interface. ICH 140 provides an interface to I/O devices or peripheral components for computer system 100. ICH 140 may comprise any suitable interface controllers to provide for any suitable communication link to MCH 130 and/or to any suitable device or component in communication with ICH 140. ICH 140 for one embodiment provides suitable arbitration and buffering for each interface.

For one embodiment, ICH 140 provides an interface to one or more suitable integrated drive electronics (IDE) drives 142, such as a hard disk drive (HDD) or compact disc read only memory (CD ROM) drive for example, to store data and/or instructions for example, one or more suitable universal serial bus (USB) devices through one or more USB ports 144, an audio coder/decoder (codec) 146, and a modem codec 148. ICH 140 for one embodiment also provides an interface through a super I/O controller 150 to a keyboard 151, a mouse 152, one or more suitable devices, such as a printer for example, through one or more parallel ports 153, one or more suitable devices through one or more serial ports 154, and a floppy disk drive 155. ICH 140 for one embodiment further provides an interface to one or more suitable peripheral component interconnect (PCI) devices coupled to ICH 140 through one or more PCI slots 162 on a PCI bus and an interface to one or more suitable industry standard architecture (ISA) devices coupled to ICH 140 by the PCI bus through an ISA bridge 164. ISA bridge 164 interfaces with one or more ISA devices through one or more ISA slots 166 on an ISA bus.

ICH 140 is also coupled to FWH 170 to provide an interface to FWH 170. FWH 170 may comprise any suitable interface controller to provide for any suitable communication link to ICH 140. FWH 170 for one embodiment may share at least a portion of the interface between ICH 140 and super I/O controller 150. FWH 170 comprises a basic input/output system (BIOS) memory 172 to store suitable system and/or video BIOS software. BIOS memory 172 may comprise any suitable non-volatile memory, such as a flash memory for example.

Additionally, computer system 100 includes translation unit 180, compiler unit 182 and linker unit 184. In an embodiment, translation unit 180, compiler unit 182 and linker unit 184 can be processes or tasks that can reside within main memory 132 and/or processors 102 and 104 and can be executed within processors 102 and 104. However, embodiments of the present invention are not so limited, as translation unit 180, compiler unit 182 and linker unit 184 can be different types of hardware (such as digital logic) executing the processing described therein (which is described in more detail below).

Accordingly, computer system 100 includes a machine-readable medium on which is stored a set of instructions (i.e., software) embodying any one, or all, of the methodologies described above. For example, software can reside, completely or at least partially, within main memory 132 and/or within processors 102/104. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

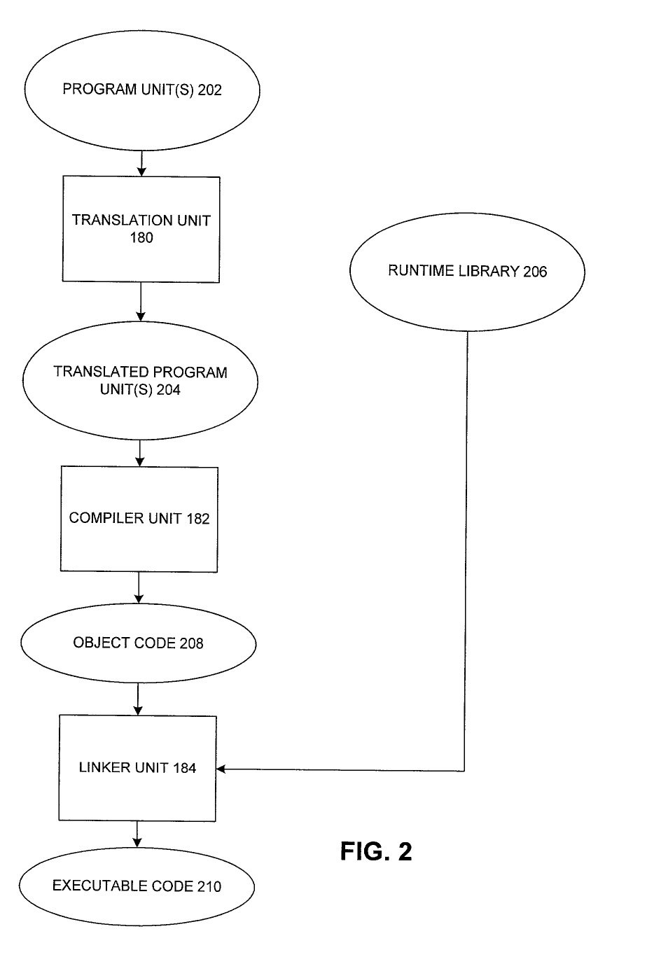

FIG. 2 illustrates a data flow diagram for generation of a number of executable program units that includes global storage objects that have been thread-privatized, according to embodiments of the present invention. As shown, program unit(s) 202 are inputted into translation unit 180. In an embodiment, there can be one to a number of such program units inputted into translation unit 180. Examples of a program unit include a program or a module, subroutine or function within a given program. In one embodiment, program unit(s) 202 are written at the source code level. The types of source code in which program unit(s) 202 are written include, but are not limited to, C, C++, Fortran, Java, Pascal, etc. However, embodiments of the present invention are not limited to program unit(s) 202 being written at the source code level. In other embodiments, such units can be written at other levels, such as assembly code level. Moreover, executable program unit(s) 210 that are output from linker unit 184 (which is described in more detail below) can be executed in a multi-processor shared memory environment.

Additionally, program unit(s) 202 can include one to a number of global storage objects. In an embodiment, global storage objects are storage locations that are addressable across a number of program units. Examples of such objects can include simple (scalar) global variables and compound (aggregate) global objects such as structs, unions and classes in C and C++ and COMMON blocks and STRUCTUREs in Fortran.

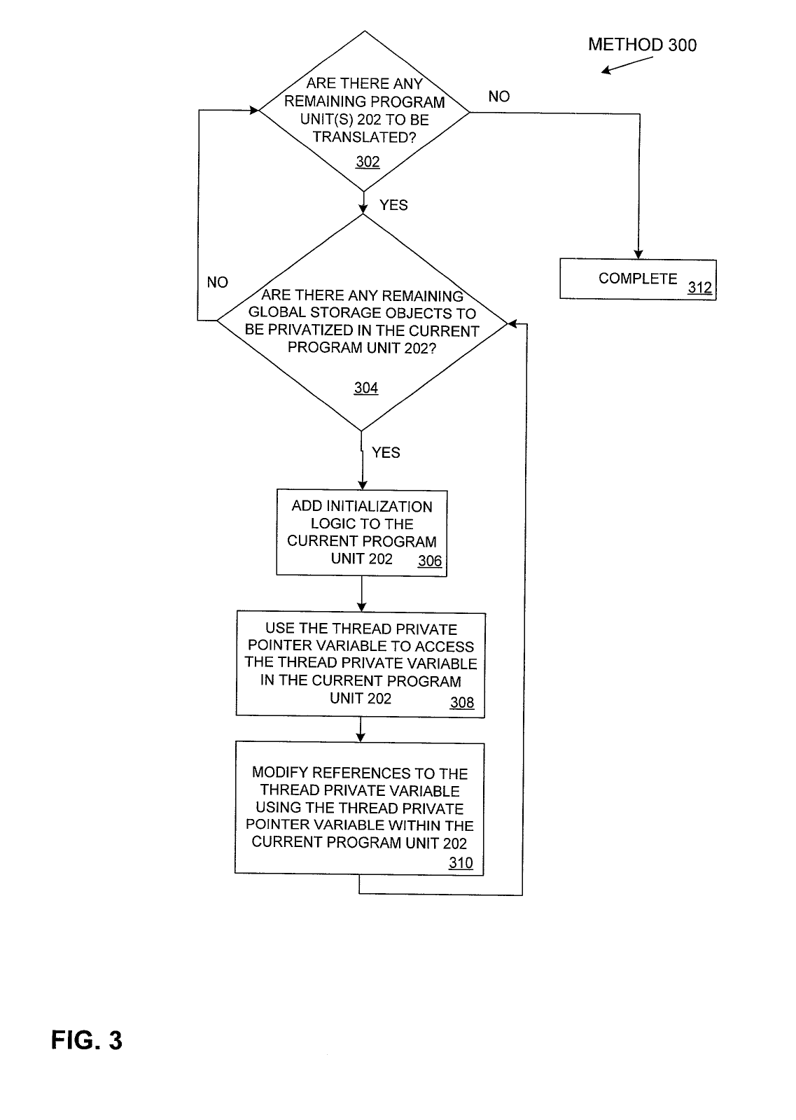

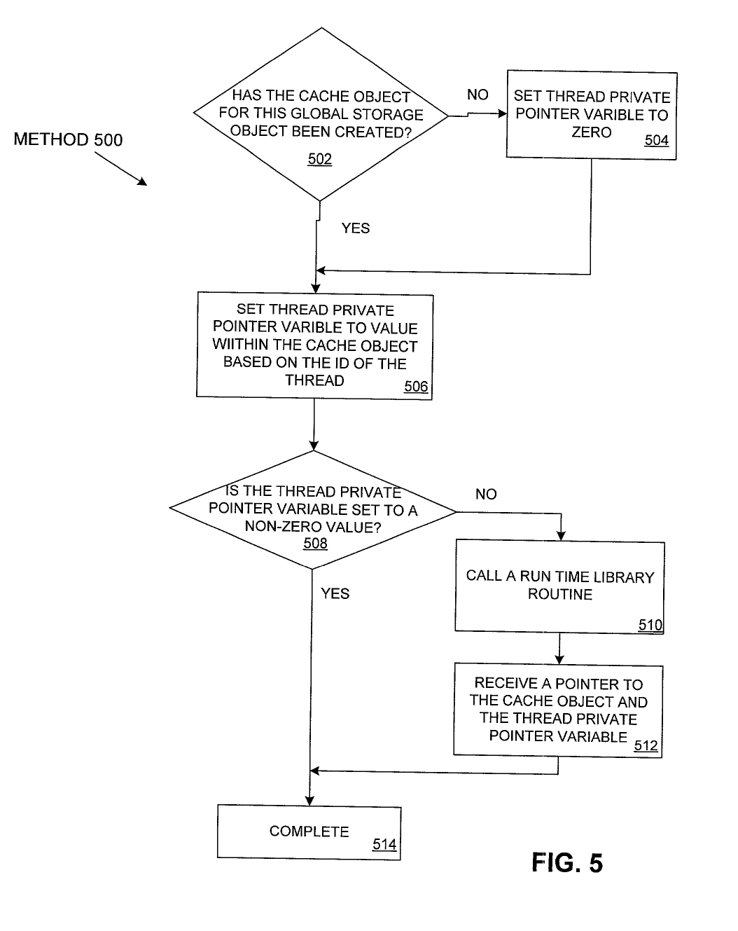

In an embodiment, translation unit 180 performs a source-to-source code level transformation of program unit(s) 202 to generate translated program unit(s) 204. However, embodiments of the present invention are not so limited. For example, in another embodiment, translation unit 180 could perform a source-to-assembly code level transformation of program unit(s) 202. In an alternative embodiment, translation unit 180 could perform an assembly-to-source code level transformation of program unit(s) 202. This transformation of program unit(s) 202 is described in more detail below in conjunction with the flow diagrams illustrated in FIGS. 3 and 5.

Compiler unit 182 receives translated program units 204 and generates object code 208. Compiler unit 182 can be different compilers for different operating systems and/or different hardware. For example, in an embodiment, compiler unit 182 can generate object code 208 to be executed on different types of Intel® processors. Moreover, in an embodiment, the compilation of translated program unit(s) 204 is based on the OpenMP industry standard.

Linker unit 184 receives object code 208 and runtime library 206 and generates executable code 210. Runtime library 206 can include one to a number of different functions or routines that are incorporated into translated program unit(s) 204. Examples of such functions or routines could include, but are not limited to, a threadprivate support function (which is discussed in more detail below), functions for the creation and management of thread teams, function for lock synchronization and barrier scheduling support and query functions for thread team size or thread identification. In one embodiment, executable code 210 that is output from linker unit 184 can be executed in a multi-processor shared memory environment. Additionally, executable program unit(s) 210 can be executed across a number of different operating system platforms, including, but not limited to, different versions of UNIX, Microsoft Windows™, and real time operating systems such as VxWorks™, etc.

The operation of translation unit 180 will now be described in conjunction with the flow diagram of FIG. 3. In particular, FIG. 3 illustrates a flow diagram for the incorporation of code into program units that generates thread privatized variables for global storage objects during the execution of such code, according to embodiments of the present invention. Method 300 of FIG. 3 commences with determining, by translation unit 180, whether there are any remaining program unit(s) 202 to be translated, at process decision block 302. Upon determining that there are no remaining program unit(s) 202 to be translated, translation unit 180 has completed the translation process, at process block 312.

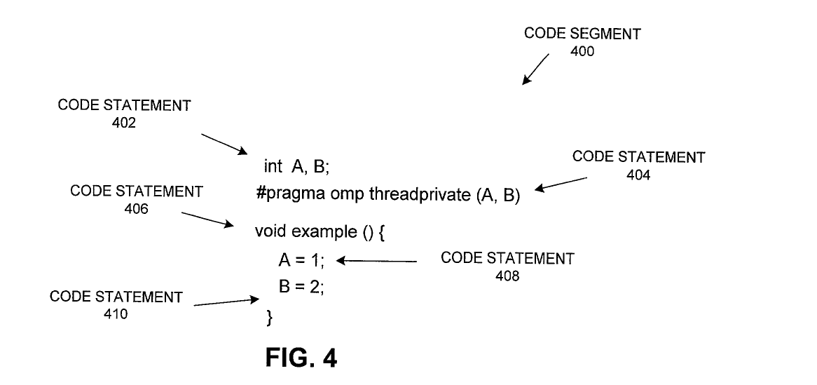

In contrast, upon determining that there are remaining program unit(s) 202 to be translated, translation unit 180 determines whether there are any remaining global storage objects to be privatized within the current program unit 202 being translated, at process decision block 304. In an embodiment, this determination is made based on the declaration of the objects within the program unit(s) 202 (i.e., the objects being defined as “thread private”). FIG. 4 illustrates code segment written in C/C++ showing objects being declared as “threadprivate”, according to embodiments of the present invention. In particular, FIG. 4 illustrates code segment 400 that includes code statements 402-410. As shown, in code statement 402, the variables A and B are declared as integers in the first line of code. Code statement 404 includes an OpenMP directive to make the variables A and B “thread private”. Additionally, the variables A and B are then set to values of 1 and 2, respectively in the function called “example( )” (at code statement 406) in code statements 408-410. Accordingly, the variables A and B are considered global storage objects that have private copies of the variables for the different threads of execution.

Returning to FIG. 3, upon determining that there are no remaining global storage objects to be privatized within the current program unit 202 being translated, translation unit 180 again determines whether there are any remaining program unit(s) 202 to be translated, at process decision block 302. Conversely, upon determining that there are remaining global storage objects to be privatized within the current program unit 202 being translated, at process block 306, translation unit 180 selects one of the number of remaining global storage objects and adds initialization logic for this global storage object to the current program unit 202, which is described in more detail below in conjunction with FIG. 5. Additionally, translation unit 180 uses the thread private pointer variable, which is set by initialization logic (at process block 306) to access the thread private variable, at process block 308. Translation unit 180 also modifies the references to the global storage object within the current program unit 202 to refer to the thread private variable pointed to by thread private pointer variable set in the initialization logic (at process block 306), at process block 310.

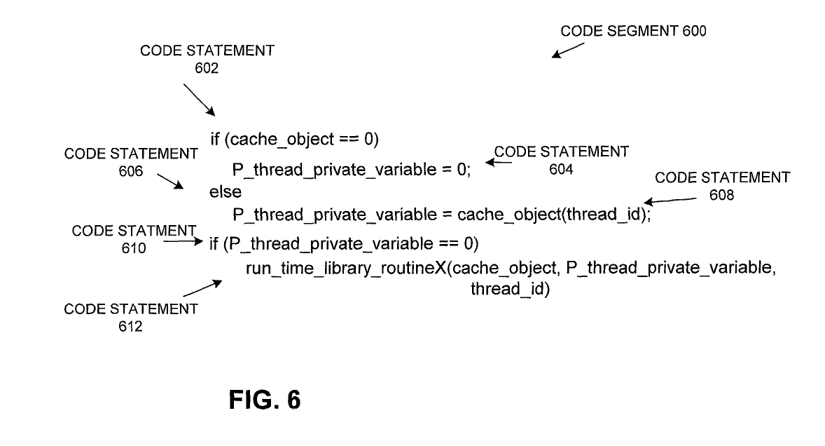

The incorporation of initialization logic to enable accessing of the thread private variables into the applicable program units will now be described. In particular, FIG. 5 illustrates a flow diagram of the initialization logic incorporated into program unit(s) 202 for each global storage object therein (referenced in process block 306), according to embodiments of the present invention. Method 500 commences with determining whether the cache object for this global storage object has been created/generated, at process decision block 502. To help illustrate, the flow diagram of FIG. 5, FIG. 6 shows a code segment of the initialization logic incorporated into program unit(s) 202 for each global storage object therein, according to embodiments of the present invention. In particular, FIG. 6 illustrates code segment 600 written in C/C++ that includes code statements 602-612. However, embodiments of the present invention are not so limited, as the code and the initialization logic incorporated therein can be written in other languages and other levels. For example, embodiments of the present invention can be written in FORTRAN, PASCAL and various assembly languages. As shown in FIG. 6, code segment 600 commences with the “if” statement to determine whether the cache object has been created/generated, at code statement 602.

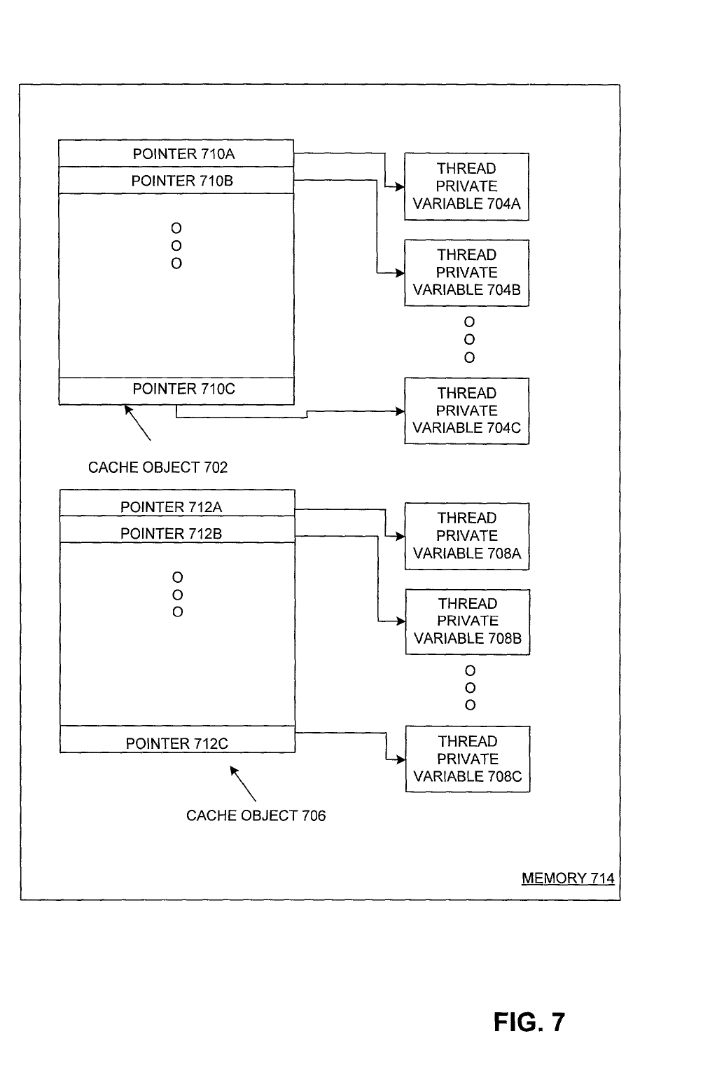

In an embodiment, the cache object is stored within the software cache. To help illustrate the cache objects, FIG. 7 shows a memory that includes a number of cache objects and memory locations to which pointers within the cache objects point, according to embodiments of the present invention. FIG. 7 illustrates two cache objects and associated thread private variables for sake of simplicity and not by way of limitation, as a lesser or greater number of such objects and associated thread private variables can be incorporated into embodiments of the present invention. Additionally, embodiments of the present invention are not limited to a single cache object for a given global storage object as more than one cache object can store the data described therein. In particular, for a given global storage object (such as “A” or “B” illustrated in the code example in FIG. 4), a cache object is generated that includes pointers to thread private variables, which are each associated with a thread that is accessing such an object. FIG. 7 illustrates memory 714, which can be one of a number of memories within system 100 of FIG. 1. For example, the global storage objects and associated thread private variables could be stored in a cache of processor(s) 102-104 and/or main memory 132 during execution of the code illustrated by method 500 of FIG. 5 on processor(s) 102-104.

As shown, memory 714 includes thread private variables 704A-C and thread private variables 708A-C. Thread private variables 704A-C and thread private variables 708A-C are storage locations for private copies of global storage objects that have been designated to include private copies for each thread, which is accessing such objects, (as described above in conjunction with FIG. 3).

Further, memory 714 includes cache object 702 and cache object 706. In an embodiment, the addresses of cache objects 702 and 706 are in a fixed location with respect to the source code being translated by translation unit 180. For example, the beginning of the source code and associated data could be at 0×50, and cache object 702 could be stored at 0×100 while cache object 706 could be stored at 0×150. While cache objects 702 and 706 can be different types of data structures for the storage of pointers, in one embodiment, cache objects 702 and 706 are arrays of pointers.

As shown, cache object 702 includes pointers 710A-710C, which could be one to a number of pointers. Moreover, each of pointers 710A-710C point to one of thread private variables 704A-C. In particular, pointer 710A points to thread private variable 704A, pointer 710B points to thread private variable 704B and pointer 710C points to thread private variable 704C. Cache object 706 includes pointers 712A-712C, which could be one to a number of pointers. Moreover, each of pointers 712A-712C point to one of thread private variables 708A-C. In particular, pointer 712A points to thread private variable 708A, pointer 712B points to thread private variable 708B and pointer 712C points to thread private variable 708C.

Returning to process decision block 502 of FIG. 5, in an embodiment, the logic introduced into the current program unit(s) 202 determines whether the cache object for this global storage object has been created/generated by accessing the fixed location for this cache object within the address of the program being translated. For example, the cache object for variable A could be stored at 0×150 within the program. In an embodiment, the logic determines whether this cache object has been created/generated by accessing the value stored at the fixed location. For example, if the value is zero or NULL, the logic determines that the cache object has not been created/generated. Upon determining that the cache object for this global storage object has not been created/generated, the initialization logic sets the thread pointer variable to a value of zero, at process block 504 (as illustrated by code statement 604 of FIG. 6).

In contrast, upon determining that the cache object for this global storage object has been created/generated, the initialization logic sets a variable assigned to the pointer (hereinafter “the thread private pointer variable”) to the value of the pointer for this particular thread based on the identification of the thread, at process block 506. With regard to code segment 600 of FIG. 6, this assignment is illustrated by the “else” statement of code segment 606 and the assignment of “P_thread_private_variable” to the value stored in the “cache_object” based on the index of the “thread_id”.

In particular, the identification of the thread is employed to index into the cache object to locate the value of the pointer. For example, if the number of threads to execute the program unit(s) 204 equals five, the thread having an identification of two would be the third value in the array if the cache object were an array of pointers (using a zero-based indexing). Accordingly, the initialization logic can determine whether the pointer located at the particular index in the cache object is set. Returning to FIG. 7 to help illustrate, for cache object 702, the thread having an identification of zero would be associated with pointer 710A. For the thread having an identification of zero, the initialization logic would determine whether pointer 710A is pointing to an address (i.e., the address of thread private variable 704A) or the value is set to zero or some other non-addressable value. Therefore, the value of this pointer could be a zero if this is the first access to this particular thread private variable. Otherwise, the value of this pointer will be set to point to the location in memory where the thread private variable is located.

Additionally, the initialization logic (illustrated by method 500) determines whether the thread private pointer variable for this particular thread is a non-zero value, at process decision block 508 (as illustrated by the “if” statement in code segment 610 of FIG. 6). Upon determining that the thread private pointer variable for this particular thread is not a non-zero value (thereby indicating that the cache object has not been created or generated and/or the thread pointer variable has not been assigned to the memory location of the thread private variable), the initialization logic calls a routine within runtime library 206 that is linked into object code 208 by linker unit 184, as shown in FIG. 2. With regard to code segment 608, this call to a runtime library routine is illustrated by code statement 612 wherein the runtime library routine (“run_time_library_routineX”) passes the cache object (“cache_object”), the thread private pointer variable (“P_thread_private_variable”) and the thread identification (“thread_id”) as parameters. The number and type of parameters passed into this runtime library routine is by way of example and not by way of limitation.

Upon determining that the address for the cache object is zero, this run time library routine allocates the cache object at the fixed address for the cache object. Additionally, the run time library routine creates/generates the thread private variable and stores the address of this variable into the appropriate location within the cache object. For example, if the cache object were an array of pointers wherein the index into this array is defined by the identification of the thread, the appropriate location would be based on this thread identification. Upon determining that the address for the cache object is non-zero, this run time library routine does not reallocate the cache object. Rather, the run time library routine creates/generates the thread private variable and stores the address of this variable into the appropriate location within the cache object. In one embodiment, the addresses of the thread private pointer variable and the cache object are returned through the parameters of the run time library routine. In another embodiment, only the address of the cache object is returned through the parameters of the run time library routine, as the address of the thread private pointer variable is stored within the cache object (thereby reducing the amount of data returned by the run time library routine). Accordingly, the initialization logic receives these addresses of the thread pointer variable and the pointer to the cache object, at process block 512. Method 500 is complete at process block 514.

Upon determining that the thread pointer variable for this particular thread is a non-zero value (thereby indicating that the cache object has been created/generated and the thread pointer variable has been assigned to the memory location of the thread private variable), the initialization logic is complete at process block 514. Therefore, as described above in conjunction with process block 308 of FIG. 3, the thread private pointer variables stored within the cache object are employed to access the thread private variable within the program unit (without requiring additional calls to the run time library routine for the address of the thread private variables).

Accordingly, embodiments of the present invention are exporting a copy of a data structure that was internal to the run time library into the program units of the code, thereby increasing the run time speed and performance of the code. In particular, a copy of the data structure is loaded into the software cache through a single access to a routine in the run time library such that subsequent accesses by a thread to its thread private variable are to the software cache and not to the run time library. Additionally, as illustrated, initialization logic is in-lined within the program unit(s) for the global storage objects to reduce the number of accesses to the run time library. As shown, translation unit 180 has introduced initialization logic that moves the accessing of the thread private variables of global storage objects from run time to compile time as the introduction of such logic enables the compiler to determine what data needs to be stored as well as the storage location of such data. Moreover, the allocation of a cache object for a given global storage object is demand driven, such that the first thread allocates the cache object with subsequent accesses to thread private variables being accessed through this single cache object by other threads executing the program units within the code.

Further, embodiments of the present invention exploit the monotonic characteristic of addresses of the cache object and the thread private variables. In particular, such addresses are initialized to a zero or NULL value and are written once to transition to the final allocated value. Embodiments of the present invention also exploit the coherent nature of a shared memory system, such that a pointer can be in one of two states (either in the original state or the modified state). Embodiments of the present invention also allow for a lock-free design after creation of the cache object in a coherent memory parallel processing environment.

Thus, a method and apparatus for accessing thread privatized global storage objects have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
receiving a first source code having a number of global storage objects, wherein the number of global storage objects are to be accessed by a number of threads during execution; and
translating the first source code into a second source code, wherein the translating includes adding initialization logic for each of the number of global storage objects , the initialization logic to include the following:
generating private copies of each of the number of global storage objects during execution of the second source code; and
generating at least one cache object during the execution of the second source code, wherein the private copies of each of the number of global storage objects are accessed through the at least one cache object during execution of the second source code.

2. The method of claim 1, wherein the at least one cache object includes a number of pointers, wherein each of the pointers points to a private copy of a global storage object for a thread.

3. The method of claim 1, wherein a private copy of a global storage object for a thread is accessed through the at least one cache object, independent of a run time library, after the private copy has been generated.

4. The method of claim 3, wherein the private copy of the global storage object for the thread is generated through execution of a routine of the run time library.

5. The method of claim 1, wherein the private copy of the global storage object for the thread is generated through execution of the second source code, independent of the run time library.

6. The method of claim 1, wherein the first source code and the second source code can be executed across at least two different platforms.

7. The method of claim 1, wherein the first source code and the second source code can be in at least two different programming languages.

8. The method of claim 1, wherein the second source code is to execute in a multi-processing shared memory environment.

9. The method of claim 1, wherein generating the at least one cache object during the execution of the second source code comprises creating the at least one cache object through an invocation of a routine within a run time library upon determining that the at least one cache object has not been generated.

10. The method of claim 9, wherein the initialization logic comprises receiving a pointer to the at least one cache object and the pointer to the private copy of the global storage object for the thread from the routine within the run time library.

11. A method comprising:
receiving a number of program units having a number of global storage objects, wherein the number of global storage objects are to be accessed by a number of threads during execution in a multi-processing shared memory environment; and
translating the number of program units into a number of translated program units, wherein the translating includes adding initialization logic for each of the number of global storage objects , the initialization logic to include the following:
generating thread private copies of each of the number of global storage objects for each of the number of threads during execution of a routine from a run time library, the thread private copies of each of the number of global storage objects generated by a routine in a run time library; and
generating at least one cache object during execution of the routine from the run time library, wherein a thread private copy of each of the number of global storage objects are accessed through the at least one cache object during execution of the second source code, independent of the run time library, after the thread private copy has been generated.

12. The method of claim 11, wherein the at least one cache object is stored in a software cache for the number of program units during execution of the translated program units.

13. The method of claim 11, wherein the at least one cache object includes a number of pointers, wherein each of the number of pointers points to a private copy of a global storage object for a thread.

14. The method of claim 11, wherein the initialization logic comprises receiving a pointer to the at least one cache object and the pointer to the thread private copy of the global storage object for the thread from the routine within the run time library.

15. The method of claim 11, wherein the first source code and the second source code can be executed across at least two different platforms.

16. The method of claim 11, wherein the first source code and the second source code can be in at least two different programming languages.

17. A system comprising:
a translation unit to receive a number of program units having a number of global storage objects, wherein the number of global storage objects are to be accessed by a number of threads during execution in a multi-processing shared memory environment, the translation unit to translate the number of program units into a number of translated program units, wherein the number of translated program units are to generate at least one cache object and to generate thread private copies of each of the number of global storage objects for each of the number of threads during execution, the thread private copies of each of the number of global storage objects generated by a routine in a run time library, wherein the thread private copies of the number of global storage objects are subsequently accessed through the at least one cache object, independent of routines in the run time library; and
a compiler unit coupled to the translation unit, the compiler unit to receive the number of translated program units and to generate object code based on the number of translated program units.

18. The system of claim 17, comprising an execution unit coupled to the translation unit, the compiler unit and the run time library, the execution unit to receive the object code and to execute the object code in a multi-processing shared memory environment.

19. The system of claim 17, wherein the first source code and the second source code can be executed across at least two different platforms.

20. A machine-readable medium that provides instructions, which when executed by a machine, cause said machine to perform operations comprising:
receiving a first source code having a number of global storage objects, wherein the number of global storage objects are to be accessed by a number of threads during execution; and
translating the first source code into a second source code, wherein the translating includes adding initialization logic for each of the number of global storage objects , the initialization logic to include the following:
generating private copies of each of the number of global storage objects during execution of the second source code; and
generating at least one cache object during the execution of the second source code, wherein the private copies of each of the number of global storage objects are accessed through the at least one cache object during execution of the second source code.

21. The machine-readable medium of claim 20, wherein the at least cache object includes a number of pointers, wherein each of the pointers points to a private copy of a global storage object for a thread.

22. The machine-readable medium of claim 20, wherein a private copy of a global storage object for a thread is accessed through the at least one cache object, independent of a run time library, after the private copy has been generated.

23. The machine-readable medium of claim 22, wherein the private copy of the global storage object for the thread is generated through execution of a routine of the run time library.

24. The machine-readable medium of claim 20, wherein the private copy of the global storage object for the thread is generated through execution of the second source code, independent of the run time library.

25. The machine-readable medium of claim 20, wherein generating the at least one cache object during the execution of the second source code comprises creating the at least one cache object through an invocation of a routine within a run time library upon determining that the at least one cache object has not been generated.

26. The machine-readable medium of claim 25, wherein the initialization logic comprises receiving a pointer to the at least one cache object and the pointer to the private copy of the global storage object for the thread from the routine within the run time library.

27. A machine-readable medium that provides instructions, which when executed by a machine, cause said machine to perform operations comprising:
receiving a number of program units having a number of global storage objects, wherein the number of global storage objects are to be accessed by a number of threads during execution in a multi-processing shared memory environment; and
translating the number of program units into a number of translated program units, wherein the translating includes adding initialization logic for each of the number of global storage objects, the initialization logic to include the following:
generating thread private copies of each of the number of global storage objects for each of the number of threads during execution of a routine from a run time library, the thread private copies of each of the number of global storage objects generated by a routine in a run time library; and
generating at least one cache object during execution of the routine from the run time library, wherein a thread private copy of each of the number of global storage objects are accessed through the at least one cache object during execution of the second source code, independent of the run time library, after the thread private copy has been generated.

28. The machine-readable medium of claim 27, wherein the at least one cache object is stored in a software cache for the number of program units during execution of the translated program units.

29. The machine-readable medium of claim 27, wherein the at least one cache object includes a number of pointers, wherein each of the number of pointers points to a private copy of a global storage object for a thread.

30. The machine-readable medium of claim 27, wherein the initialization logic comprises receiving a pointer to the at least one cache object and the pointer to the thread private copy of the global storage object for the thread from the routine within the run time library.
